(19) United States
(12) Patent Application Publication
(10) Pub. No.: US 2024/0000088 A1
(43) Pub. Date: Jan. 4, 2024

(54) A METHOD OF TRACKING A FOOD ITEM IN A PROCESSING FACILITY, AND A SYSTEM FOR PROCESSING FOOD ITEMS

(71) Applicant: MAREL SALMON A/S, Stovring (DK)

(72) Inventors: Anders KJAER, Stovring (DK); Martin ANDERSEN, Stovring (DK)

(21) Appl. No.: 18/039,417

(22) PCT Filed: Dec. 3, 2021
(86) PCT No.: PCT/EP2021/084176

§ 371 Date: May 30, 2023

(30) Foreign Application Priority Data
Dec. 4, 2020 (EP) 20212004.4

(51) Int. Cl. A22C 17/00; A22C 21/00; A22C 25/04; A22C 25/08; G06K 19/06; G06T 7/246; G06V 20/68; G06V 20/50

(52) U.S. Cl. CPC A22C 17/0073; A22C 21/0053; A22C 25/04; A22C 17/0093; G09F 3/02; G06K 19/06028; G06T 7/246; G06V 20/68; G06V 20/50; A22C 25/08

(57) ABSTRACT

A method and a system for automatically tracking a food item in a processing facility involves a food item that is received in a check-in position where a check-in image is captured, and a unique identification insignia, UII is generated based on the check-in image. The food item is handled and moved to a check-out position where a check-out image is captured. To facilitate automatic tracking of the food items, a recognition process is carried out to establish if a check-out image can be assigned to the created UII, and a data-record is, in that case, generated with the recognized UII.

### INTRODUCTION

The disclosure relates to a method and a system for tracking food items through a processing facility, and particularly to a method where food items are received in a flow of food items, and a check-in image is acquired at a check-in position.

### BACKGROUND

In food processing plants, food items are often delivered sequentially to workstations, e.g. for trimming, filleting, sorting, or bone removal etc.

Workstations are often located along a conveyor and operators, robots, or handling means such as knives can access the food items either while they move or while they are placed on an interim processing table from which they are returned back to the conveyor after the processing.

It is commonly known to uniquely identify food items during processing. In one example, animals raised for slaughtering are provided with a unique identification tag, typically with a bar code, number, or with other forms of electronically readable identification. Such an identification allows data related to weight, fat percentage, quality, or processing line within the processing facility to be identified. If necessary, such data can be useful, e.g. to trace contamination or generally to comply with customer requirements for authentication of food items.

While tags, labels, and similar separately applied identifiers may, unintentionally, separate from the food item during processing and thereby become useless, printed marks, burned embossing, and similar physical marking directly into the food item may be undesired, e.g. for aesthetic reasons.

### SUMMARY

To improve the ability to track food items during processing, the present disclosure in a first aspect provides a method of automatically tracking a food item in a flow of food items through a handling facility.

The method comprises:
receiving the food item in a check-in position;
acquiring at least one check-in image of the food item;
creating at least one unique identification insignia (UII) from the check-in image;
moving the food item or pieces thereof in the flow of food items through the handling station to a check-out position;
acquiring at the check-out position, at least one check-out image of the food item or a piece thereof;
conducting a recognition process configured to establish if the check-out image can be assigned to the created UII; and
if it could be established that the check-out image can be assigned to the created UII, defining a data-record including the assigned UII.

Particularly, the food item could be moved through the handling facility by a conveyor system forming a path from the check-in position and a camera providing the check-in image of the food item, past the handling station, and further to the check-out position and another camera providing the check-out image.

The recognition process is to recognize from the at least one check-out image if it can be assigned to one of the created UIIs.

Since the UII is recognized in the check-out image, the image of the food item itself serves as identification and tags, labels, stamping, or similar physical identification marks can be avoided between the check-in position and the check-out position.

The data-record could be stored in a database or it could be affixed to the food item or to a packaging thereof at the check-out position.

The food item could e.g. be an item from the list consisting of vegetables, fruits, meat, poultry, fish, and seafood. The food item could be cut into several pieces. I.e. herein, the term “piece” refers to a part which is cut off from the food item. The term part refers to an area of the food item not necessarily cut off from the food item and therefore not necessarily forming a piece of the food item.

The UII could be a numerical format, e.g. a data string e.g. with integers, and it may be defined e.g. by a process using an algorithm which translates the picture into such a numerical format.

The check-in image and/or the check-out image could be captured with image capturing means known in the art, including cameras capturing electromagnetic radiation, e.g. line or matrix type CCD cameras or any similar kind of camera, including cameras capturing electromagnetic radiation outside the visible range, e.g. x-ray cameras. The check-in image and/or the check-out image could also be captured with ultrasound.

The handling station could include one or more, or combinations, of stations for sorting, weighing, cutting, slicing, trimming, pin-bone removing, batching, packing, or simply counting or registering the food item. Accordingly, the food item may be cut into several pieces after having passed the handling station.

The food items could particularly be moved by use of a conveyor system, e.g. with conveyor belts.

By “recognizing from the at least one check-out image, the created UII” is herein meant that, at the check-out position, the food item is assigned to its originally assigned UII based on the check-out image.

In one embodiment, an additional UII, herein referred to as a check-out UII, is created based on the check-out image. The check-out UII is created in the same way, e.g. by use of the same algorithm and procedure which was used to create the UII based on the check-in image. Subsequently, the check-out UII is compared with the UII.

The recognition process may recognize that the check-out image can be assigned to one of the created UIIs, if the check-out UII is identical to the UII, or if it is at least partly identical to the UII.

If the UII and the check-out UII are numerical values, e.g. contained in data strings, then the recognition process may include comparing the numerical values or data strings and evaluating a certain amount of distance or overlap.

In one example, a check-in image is turned into a first array of digits and that process is repeated to define a second array of digits with the check-out image. As a result, the second array could be identical e.g. for all digits, or for a part of the digits, e.g. for 12 out of 15 digits. The recognition process may include defining a threshold for the number of overlapping digits, e.g. a threshold of at least 10 out of 15 being a limit for considering the UII to be “recognized”. If less than 10 out of 15 digits are identical, the recognition process may return “lack of recognition”, and otherwise, it may return the recognized UII.

The method may include a step of combining the UII with meta data related to the processing facility or related to the food item, e.g. data received with the food item i.e. data obtained prior to entering the check-in position.

Examples of such meta data may include data originating from a farm or place where the food item is originally produced, or simply an identifier of such a farm or place. It may include information related to weight, size, shape, or quality of the food item, and it may include e.g. use of pesticides on vegetables, or vaccine used in animals.

Examples of meta data related to the handling station may include identification of equipment used for processing, identification of operators having handled or processed the food item, or it may specify parameters of the environment, e.g. temperature or humidity etc.

In one example, the meta data identifies capabilities of the handling station e.g. relative to the capability to split the incoming food items or pieces thereof into different categories leaving the facility in different check-out positions, e.g. some items or pieces thereof being graded differently or some items or pieces thereof being rejected.

The meta data and the UII may be combined in a data file. In this way, the image of the food item or pieces thereof is related to the meta data.

The method may include a step of defining further handling stations and a step of selecting a defined processing station for the food item or the piece thereof and generating a data file containing an identification of the selected processing station and the UII. The selection of the further handling station may e.g. be based on information in the meta data.

The terms ‘processing station’ and ‘handling station’ may herein be interchangeable unless otherwise specified.

By means of an example, the data file may express that a food item with a certain UII generated based on the check-in image may have a certain quality parameter justifying that it is packed without further processing such as trimming, or it may specify that the food item is rejected etc.

The method may further comprise selecting a specific one of the defined further processing stations and assigning it to food items or the piece thereof when the UII cannot be recognized from the at least one check-out image. A food item may e.g. not be recognized at the check-out position, and the identity of that food item is therefore not available. It may, as an example, be decided that such food items are sold for a lower price or used in a different context, e.g. in pre-processed food products, e.g. in cooked state.

The method may comprise a step of identifying in the check-in image an undesired food item part and creating the UII from a part of the image which does not contain the undesired food item part. Examples of such undesired parts could be parts having a high content of fat, bones, cartilage etc., it could be a part with an undesired color, e.g. created by a blood stain, it could be foreign objects, e.g. blue plastic, needles, or it could be defects of the food item.

For the sake of being able to recognize the UII based on the check-out image, it may be desirable to generate the UII based on more image information than needed for defining the UII to thereby make the recognizing process robust relative to changes between the check-in image and the check-out image. Such processes exist in the art, and they are generally based on redundant image data included for the UII generation and subsequent identification of the UII. In one example, a UII consists of at least 15 digits, but for making the recognition more robust, it could be generated with 20 digits or more.

The method may also comprise establishing a plurality of UIIs for each food item. The UIIs could e.g. be established for different parts of the food item. That may enable recognition of the UII for individual pieces, e.g. if undesired parts are cut away or if the food item is cut into pieces in the handling station between the check-in position and the check-out position.

The method may e.g. comprise defining in the check-in image, a portioning plan defining cutting of the food item into pieces thereof and creating a UII for each of the pieces thereof. Each piece of the food item can thereby be recognized individually at the check-out position.

The method may comprise generation of the UII based on a structural uniqueness of the food item. Examples thereof include fat, bone, or muscle fiber pattern, cartilage, sinews and other unique structures of the food item. It could also be generated based on a size or shape of the food item or generated based on a color or color distribution of the food item, or combination thereof. In one example, the UII is generated based on a thickness profile of the food item, e.g. determined by the check-in image taken by a line scan camera while the food item is conveyed on a conveyor belt.

The method may comprise a step of establishing a que of UII of food items for which a check-in image is acquired at the check-in position and deleting from the que, a UII which is recognized in the check-out image.

If a plurality of UIIs is generated for one and the same check-in image, these UIIs may be grouped in a set of UIIs, and the method may include the step of deleting all UII's of a set of UIIs from the que if the recognition process establishes that one or more check-out images can be assigned to a predetermined number of UIIs from that set of UIIs. The predetermined number could be “all UIIs of the set of UIIs” or a certain percentage, e.g. when 90 percent of the UIIs of a set of UIIs are recognized in the check-out image. This allows the que to be reduced once a major part of pieces originating from the food item has passed the check-out position.

A check-in time could be assigned to each UII thereby establishing when the UII is created. Subsequently, UIIs could be deleted from the que when a predetermined time has elapsed. That may keep the number of UIIs in the que down to a level where the que contains only relevant UIIs and thereby enable a faster and more efficient recognition process.

The que defines a moving window with a relatively small amount of UIIs being potentially recognizable in the check-out image and it limits the risk of recognizing false UIIs. Particularly, if the recognition process includes evaluation of a best match between a UII and a check-out UII it may improve the ability to provide correct recognitions even though the UII and the check-out UII are not necessarily identical.

The method may be carried out for a large variety of food items, e.g. vegetables, fruits, meat, poultry, fish, and seafood. Particularly, the method may be used in handling fish such as fillets of fish, e.g. salmon fillets, meat, such as fillets of beef, pork, poultry, or slices thereof.

In one embodiment, the food items or pieces thereof are categorized in at least a first category and a second category. The categorization is carried out between the check-in position and the check-out position, and could e.g. relate to different quality criteria. In one embodiment, food items or pieces thereof being in the first category is directed through the check-out position and food items or pieces thereof being in the second category is not directed through the check-out position.

In one example, the food items or pieces thereof being in the second category could be rejected or be transferred to another check-out facility. The facility may e.g. comprise 2, 3 or more different outlets pertaining to different categories.

A que of UII's of food items for which a check-in image is acquired at the check-in position may be established. This que could be said que mentioned previously, i.e. the que which is updated when food items or pieces thereof passes the check-out position, or a time out duration expires.

Food items or pieces thereof could be deleted from the que when they are categorized as second category or other categories not supposed to pass the check-out position. In that case, the food item could be passed out through an alternative check-out position. This feature may be used e.g. when the food item or pieces thereof is rejected between the check-in position and the check-out position. Here ‘rejected’ means ‘not suitable for a certain use’, and may thus include a down grading of the food item or pieces thereof for another use, which may include use for human consumption.

In addition to the generation of a data-record with the assigned UII for those food items or pieces thereof where the check-out image could be assigned to the created UII, the method may include defining a data-record for all food items passing the check-out position. In that case, a check-out id could be defined for each and every food item at the check-out position, and the data-record may include the check-out id and optionally an UII in those cases where the check-out image can be assigned to the created UII. When no UII can be assigned, the data-record may simply be omitted, or the data-record may include the information that no UII could be assigned.

In a second aspect, the disclosure provides a system for processing food items and with automatic tracking capability. Such a system comprises:
at least one conveyor configured to move the food item from a check-in position to at least one processing station and to a check-out position;
a check-in camera arranged at the check-in position and configured to capture check-in images of the food items;
a processing structure configured to create unique identification insignias (UII's) from the check-in images; and
a check-out camera arranged at the check-out position and configured to capture check-out images of the food items or pieces thereof.

The processing structure is configured to conduct a recognition process configured to establish if the check-out image can be assigned to the created UII; and if it could be established that the check-out image can be assigned to the created UII, to define a data-record including the assigned UII, e.g. in combination with a check-out id.

Corresponding to the method of the first aspect, the processing structure may define a data-record to each and every food item or pieces thereof passing the check-out position and depending on whether or not the UII was recognized, the UII is included in or omitted in the data-record.

The processing structure may be configured to establish a que of UIIs of food items for which a check-in image is acquired at the check-in position and to delete from the que, a UII which is recognized in the check-out image.

The system may further be configured to assign a check-in time to each UII when created, and to delete a UII from the que when a predetermined time has elapsed.

The system may further include a sensor configured to determine a lead time for the food items from the check-in position to the check-out position, and wherein the predetermined time is dynamically updated based on the lead time.

The system may particularly comprise a conveyor structure allowing a gap to be formed between an infeed section and an outfeed section, where infeed and outfeed are relative to the gap between the two sections and where the infeed and/or outfeed section can be moved relative to the gap. In connection with the gap, a knife may be located and during a cutting process for cutting/portioning food items a cut off piece can be directed through the gap or an end piece of a food item can be directed through the gap.

Such a structure with or without a process being performed at the gap may allow rejection of food items or pieces thereof in a location between the check-in position and the check-out position. In case of salmon processing and processing of fish in general, the food item may be a whole fish, and the pieces thereof may include a tail part or a head part which is typically rejected between the check-in position and the check-out position.

Additionally, the system according to the second aspect may include any feature implicit in view of the method according to the first aspect of the disclosure.

### LIST OF EMBODIMENTS

1. A method of automatically tracking a food item in a processing facility, the method comprising:

Receiving the food item;
moving the food item to a check-in position;
acquiring at least one check-in image of the food item;
creating at least one unique identification insignia (UII) from the check-in image;
moving the food item from the check-in position to at least one handling station;
moving the food item or a piece thereof from the handling station to a check-out position;
acquiring at the check-out position, at least one check-out image of the food item or the piece thereof; and
recognizing from the at least one check-out image the created UII.

2. The method according to embodiment 1, comprising creating a plurality of UIIs from the check-in image.

3. The method according to embodiment 2, wherein the plurality of UIIs comprises a UII relating to one part and other UIIs relating to different parts of the check-in image and thus different parts of the food item.

4. The method according to embodiment 3, wherein the different parts are overlapping parts.

5. The method according to any of embodiments 2-4, comprising defining for each food item a set of UIIs defining a relationship between the UIIs belonging to the same food item.

6. The method according to any of the preceding embodiments, comprising establishing a que of UII's of food items for which a check-in image is acquired at the check-in position and deleting from the que, a UII which is recognized in the check-out image.

7. The method according to embodiments 5 or 6, comprising deleting all UII's from the set of UIIs when a predetermined number of UIIs from that set of UIIs have been recognized in the check-out image.

8. The method according to embodiment 6 or 7, further comprising assigning a check-in time to each UII establishing when the UII is created and deleting a UII from the que when a predetermined time has elapsed.

9. The method according to any of the preceding embodiments, combining the UII with meta data related to the handling station, received with the food item, or obtained at the check-in position.

10. The method according to any of the preceding embodiments, comprising defining further handling stations for processing of the food items after the check-out position, selecting a defined processing station for the food item or the piece thereof, and generating a data file containing an identification of the selected processing station and the UII.

11. The method according to embodiments 9 or 10 wherein the selection is based on information in the meta data.

12. The method according to embodiment 10 or 11, comprising selecting a specific one of the defined further processing stations and assigning it to food items or the pieces thereof when the UII cannot be recognized from the at least one check-out image.

13. The method according to any of the preceding embodiments, comprising identifying in the check-in image an undesired food item part and creating at least one UII from a part of the image which does not contain the undesired food item part.

14. The method according to any of the preceding embodiments, comprising identifying in the check-in image an undesired food item part and creating at least one UII from a part of the image which does contain the undesired food item part.

15. The method according to embodiment 14, comprising the step of identifying at least one UII from a part of the image which does contain the undesired food item part, and rejecting a food item or a piece thereof containing the undesired food item part upon the recognition.

16. The method according to any of the preceding embodiments, comprising defining based upon the check-in image a portioning plan defining cutting of the food item into pieces thereof, and creating at least one UII for each of the pieces thereof.

17. The method according to any of the preceding embodiments, wherein the UII is generated based on a structural uniqueness of the food item, or generated based on a size or shape of the food item or pieces thereof, or generated based on a color or color distribution of the food item, or combinations thereof.

18. The method according to any of the preceding embodiments, wherein the food item is selected from the group consisting of: vegetables, fruits, meat, poultry, fish, and seafood, or slices thereof.

19. The method according to any of the preceding embodiments, wherein the food item is Salmon such as a fillet of salmon.

20. The method according to any of the preceding embodiments, wherein food items or pieces thereof are categorized in at least a first category and a second category, the categorization being carried out between the check-in position and the check-out position, and wherein food items or pieces thereof being in the first category is directed through the check-out position and wherein food items or pieces thereof being in the second category is not directed through the check-out position.

21. The method according to embodiment 20, comprising establishing a que of UII's of food items for which a check-in image is acquired at the check-in position and deleting from the que, a UII for a food item or a piece thereof which is categorized in the second category.

22. A system for processing food items and with automatic tracking capability, the system comprising:
at least one conveyor configured to move the food item from a check-in position to at least one processing station and to a check-out position;
a check-in camera arranged at the check-in position and configured to capture check-in images of the food items;
a processing structure configured to create unique identification insignias (UII's) from the check-in images; and
a check-out camera arranged at the check-out position and configured to capture check-out images of the food items or pieces thereof;
   wherein the processing structure is configured from the at least one check-out image to recognize a created UII.

23. The system according to embodiment 22, wherein the processing structure is configured to establish a que of UII of food items for which a check-in image is acquired at the check-in position and to delete from the que, a UII which is recognized in the check-out image.

24. The system according to embodiment 23, wherein the processing structure is further configured to assign a check-in time to each UII when created, and to delete a UII from the que when a predetermined time has elapsed.

25. The system according to embodiment 24, comprising a sensor configured to determine a lead time for the food items from the check-in position to the check-out position, and wherein the predetermined time is dynamically updated based on the lead time.

### BRIEF DESCRIPTION OF THE DRAWINGS

In the following, embodiments of the disclosure will be described in further details with reference to the drawing in which:

FIG. 1 illustrates schematically main components of a system according to the disclosure;

FIG. 2 illustrates further details of a system according to the disclosure;

FIG. 3 illustrates a food item with an identifiable structural uniqueness;

FIG. 4 illustrates a food item with an area of a lower quality e.g. with an undesired element;

FIG. 5 illustrates the food item from the previous FIG. 4 but with an overlapping portioning plan;

FIG. 6 illustrates a food item for which a plurality of UIIs is created in the check-in image; and

FIG. 7 illustrates a timeline.

### DETAILED DESCRIPTION OF VARIOUS EMBODIMENTS

The detailed description and specific examples, while indicating embodiments, are given by way of illustration only, since various changes and modifications within the spirit and scope of this disclosure will become apparent to those skilled in the art from this detailed description.

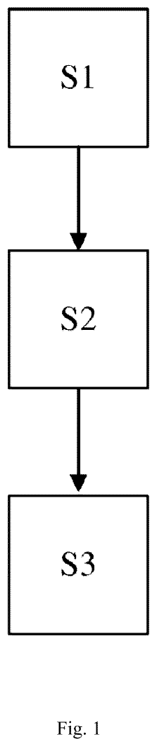

FIG. 1 illustrates schematically a system comprising three stations, named S1, S2 and S3. The three stations could be connected e.g. by a conveyor or they could simply be three stations arranged at three different locations of a table. S1 could represent a check-in position. S2 could represent a handling station, e.g. a processing station where the food item is processed or handled in other ways. Examples of such handling could be sorting, counting, marking, filleting, trimming, weighing, batching or any similar kind of known handling of food items. S3 could represent a check-out position.

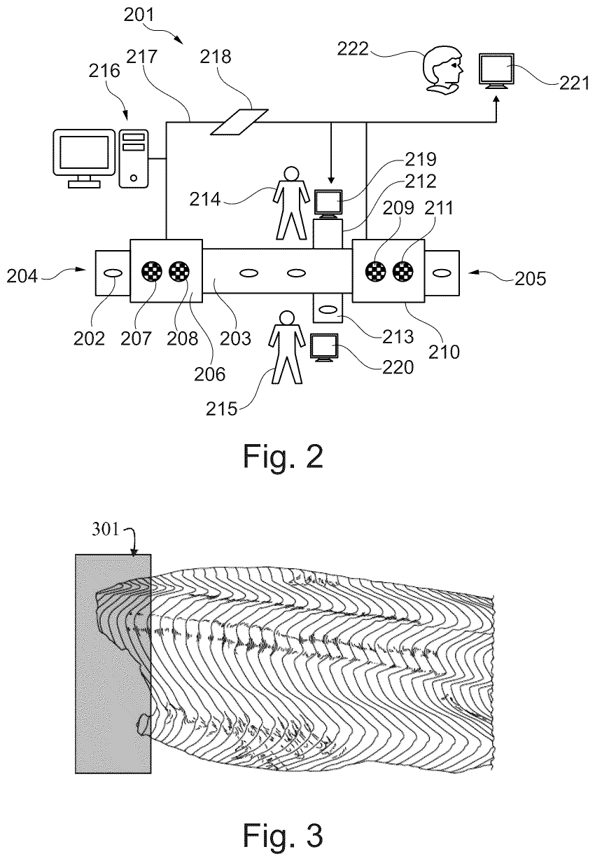

FIG. 2 illustrates an example of such a system depicted schematically in FIG. 1. In FIG. 2, the system 201 is illustrated with further details. The exemplified system is configured for operator assisted processing of food items 202 but it could be fully automatic processing, or it may be a simple handling of the food item, e.g. simply registering the food item for packing.

The illustrated system has automatic tracking capability allowing each food item which enters the system to be recognized when it leaves the food processing system. The illustrated facility comprises a conveyor 203 which transports food items from the intake 204 to the outlet 205.

A check-in position 206 is defined along the conveyor. At this position, a check-in camera 207 is located such that it can capture check-in images of the food items. In the illustrated embodiment, the check-in camera is located above the conveyor and lamps 208 may be arranged to provide enough light for recognizing even fine details in the food items. The camera 207 is based on visual light reflection, but in alternative embodiments, the camera could be X-ray based or ultrasound based etc.

The check-out camera 209 is arranged at the check-out position 210 where it can capture check-out images of the food items or pieces thereof e.g. by the assistance of lamps 211 etc. Cameras 207 and 209 may be arranged before corresponding lamps 208 and 211, however lamps may also be positioned before cameras or at any other suitable locations.

Between the check-in position and the check-out position, the food items are handled at a handling station. In this case, the handling station comprises two processing tables 212, 213. Alternatively, such handling stations may comprise automatic processing equipment.

An operator 214, 215 may be assigned to each processing table. Each table and each operator have individual IDs, e.g. in the form of an identification number.

The computer 216 comprises a data input configured to receive the captured images from the check-in camera and from the check-out camera, e.g. via a Local area network, LAN 217. A CPU with corresponding software code is configured to form a processing structure and to create a unique identification insignia (UII) based on the check-in images and to recognize that UII in the check-out images. The computer 216 may generate a data-record 218, symbolized by the product card 218. The data-record may contain the UII and other kinds of data, e.g. meta data related to the food item or to the handling of the food item, e.g. the ID of the operator etc.

Each table may have computer interfaces, e.g. in the form of touch screens 219, 220 enabling the operator to identify the food item, to generate information related to the food item. Such information may specify the ID of the operator, the ID of the table, or visually observed issues related to the food item, e.g. quality parameters observed by the operator. The information can be transmitted by the LAN 217 to the computer 216 or elsewhere, e.g. to the supervisor computer system 221 where a supervisor 222 may review the data. The data could be included as meta data in the data-record 218. Data, e.g. as included in the data-record, could also be exported e.g. to adjacent handling stations, or to follow the food item or pieces thereof all the way to the consumer.

The outlet could be arranged to deliver the food items or pieces thereof to adjacent handling stations, e.g. for further processing, packing, inspection, or rejection etc.

The system may comprise a diverter which can be controlled by the processing structure such that, depending on the recognizing of the food item or the piece thereof at the check-out position, the food item is directed to one or the other of the subsequent processing stations. By means of an example, the processing structure may have a list of N specific food items with corresponding UII. If these N food items are to be packed for a specific customer, the food item diverter could be controlled by the processing structure to direct these specific food items to a packing station dedicated to the specific customer. If a specific food item can't be recognized at the check-out position, the processing structure may use a preselected subsequent processing station, e.g. a processing station with a human operator who can decide an action for the non-recognized food item.

The UII could be generated based on a structural uniqueness of the food item. Examples of such structural uniqueness is shape and size of fat, bone, muscle, fiber patterns. It could also be generated based on a shape or size of the food item or generated based on a color or color distribution of the food item.

Particularly, the check-in image may be an image of a food item which is prepared for obtaining the best image of this unique feature.

FIG. 3 illustrates a fish, particularly a salmon fillet. The illustrated salmon is filleted. This process reveals a structure of meat and fat, and that structure may be used for obtaining a good image representing a unique “fingerprint” which can define the UII. If filleting is desired, the system may particularly contain a filleting station placed prior to the check-in position to enable a check-in image containing the fingerprint structure of the fillet.

The gray area indicated by the box 301 is typically cut away and rejected to be processed differently. The pieces of the salmon within the gray box 301 could be categorized as a food item piece not supposed to pass through the check-out position. Accordingly, it may be an object to remove a UII from such a piece of the food item from a que of UIIs to thereby facilitate faster or more robust identification of the remaining UIIs in the check-out image.

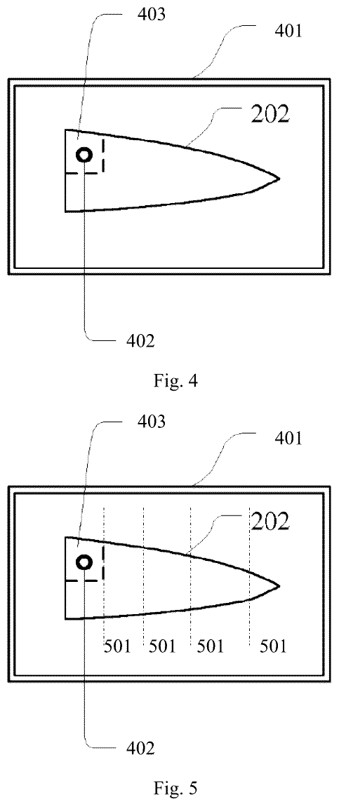

The food item illustrated in FIG. 4 has been captured on a check-in image 401. The processing structure identifies a blood stain 402. Such a blood stain is generally undesirable and therefore typically cut away during the processing.

Since such cutting could take place between the check-in position and the check-out position it may be desirable not to use an area around the blood stain for the purpose of generating the UII, or at least to generate a UII based on a principle which is robust against removal of parts of the food item and thus a part of the image.

If such an undesired element of the food item is removed, it may impair the ability of the process structure to recognize the UII in the check-out image. Accordingly, the processing structure is programmed upon identifying such an undesired food item part and to create a frame 403 around the blood stain 402 and to generate the UII from a part of the image which does not include the frame 403.

FIG. 5 illustrates the food item from the previous FIG. 4 but with an overlapping portioning plan defining cutting lines 501 for cutting the food item into pieces. The portioning plan is used for controlling a portioning cutter placed between the check-in position and the check-out position. Due to this process, it may be difficult to recognize the UII and for that reason, the processing structure is configured for creating a UII for each of the pieces according to the portioning plan.

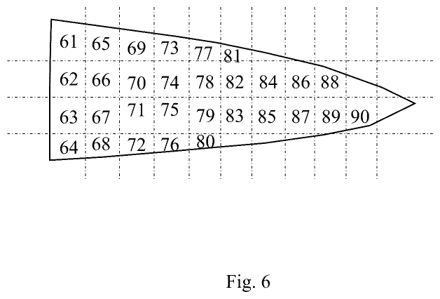

FIG. 6 illustrates a food item for which a plurality of UIIs is created in the check-in image. The created UIIs are uniquely numbered 61-90, and they relate to different unique parts of the food item. In alternative embodiments, at least some of the UIIs may relate to overlapping parts of the food item.

The computer 216 may define for all these UIIs which relate to the same food item, a set of UIIs defining the relationship between the UIIs belonging to the same food item. As an example, all UIIs 61-90 may be defined as UII 1-61, 1-62, 1-63 . . . 1-90, thereby defining that they belong to food item no. 1.

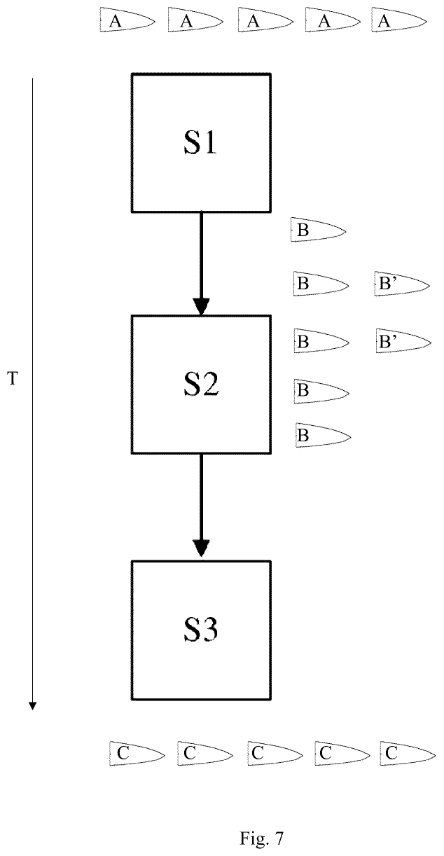

FIG. 7 illustrates a timeline T indicating a lead time defined herein as the duration from a food item enters the check-in position S1 until it leaves the check-out position S3. Depending on the specific layout of the system, a finite number of food items are processed, e.g. simultaneously or successively. To increase the efficiency of the system and particularly to increase the ability of the processing structure to recognize a created UII from the check-out image, it may be an advantage to reduce the number of food items which are considered by the processing structure.

In FIG. 7, the five food items marked with A are to enter the check-in position S1. The seven food items marked with B are being handled. Five of these are in flow, and two of the seven food items, i.e. those marked B′ are currently parked between the check-in position S1 and the check-out position S3. The reason for parking food items could be lack of available resources, e.g. due to uneven processing needs for the incoming food items. If several successive food items need specific processing, the capacity for handling the food items may necessitate parking of food items until they can be processed.

The computer 216 comprises a memory in which a que of UII of food items marked B is stored.

Each time a food item arrives at the check-in position, the que is updated with a new UII. Each time a food item leaves the check-out position and is recognized by the check-out image to have a specific UII, the corresponding UII is deleted from the que. In that way, the que only contains a limited number of available UIIs and the ability to recognize the UII correctly can be increased. The feature is particularly relevant when the UII is generated based on a feature, e.g. a structure, size, shape, or color which with statistically good probability may be considered unique within a relatively low amount of items, but which could not be considered unique in larger amounts of the food item.

FIG. 7 indicates by the timeline T that a clock is built into the computer. The clock is indicative of a function of the processing structure to assign a check-in time to each UII when created. Based on knowledge about the specific layout, it may be determined that a food item would normally have left the system at a predetermined point in time. Accordingly, the check-in time could be used for deleting UIIs from the que when the predetermined period has elapsed. That may occur, e.g. if the parked food items B′ for some reason are rejected.

In one implementation, the check in-camera and the check-out camera are CCD cameras arranged along a conveyor belt. The cameras communicate digital images with the processing structure. The processing structure comprises an image recognizing unit providing a converter capable of converting a digital image from the check-in or check-out camera to a unique data-record. A communication unit is capable of outputting the data-record to other computers, e.g. for label printing purposes or for later authentication of the food item, or storing the data-record in a database.

Internally, the data-record is preserved in memory, and an image signal processing unit in the form of a microprocessor is configured to carry out the reorganization procedure in which it is verified if a check-out image and a check-in image is from the same food item. The microprocessor is programmed with software developed with similar techniques as standard software developed for recognizing features in images. Such systems are widely developed, e.g. for face detection or fingerprint recognition.

The processing structure may include a video card with a frame buffer and other features configured for handling input from the camera, and the UII could be generated based on standard processor functions available e.g. for face recognition, fingerprint recognition etc. Such processors can deliver a unique data-string representing a UII for a picture.

1.-31. (canceled)

32. A method for tracking a food item in a flow of food items through a handling facility, the method comprising:
receiving the food item in a check-in position;
acquiring at least one check-in image of the food item;
creating at least one unique identification insignia (UII) from the check-in image;
moving the food item or pieces thereof in the flow of food items through a handling station to a check-out position;
acquiring at the check-out position, at least one check-out image of the food item or a piece thereof;
conducting a recognition process configured to establish if the check-out image can be assigned to the created UII; and
if it could be established that the check-out image can be assigned to the created UII, defining a data-record including the assigned UII.

33. The method according to claim 32, further comprising storing the data-record in a database or printing the data-record on a label.

34. The method according to claim 32, further comprising:
defining a first handling station for further handling of the food item or the piece thereof,
defining a second handling station for further handling of the food item or the piece thereof,
selecting one of the first and second handling stations if the recognition process establishes that the check-out image can be assigned to the created UII; and
selecting another one of the of the first and second handling stations if the recognition process establishes that the check-out image cannot be assigned to the created UII.

35. The method according to claim 32, comprising creating a plurality of UIIs from the check-in image.

36. The method according to claim 35, wherein the plurality of UIIs comprises a UII relating to one part of the check-in image and other UIIs relating to other parts of the check-in image such that the plurality of UIIs relate to different parts of the food item.

37. The method according to claim 36, wherein the different parts are overlapping parts.

38. The method according to claim 35, further comprising grouping the UIIs in a set of UIIs when the UIIs are created from the same check-in image or from the same food item.

39. The method according to claim 32, comprising establishing a que of UII's of one or more food items in the flow of food items and deleting from the que, a UII if the recognition process establishes that a check-out image can be assigned to that UII.

40. The method according to claim 38, comprising deleting all UII's of a set of UIIs if the recognition process establishes that one or more check-out images can be assigned to a predetermined number of UIIs from that set of UIIs.

41. The method according to claim 39, further comprising assigning a check-in time to each UII establishing when the UII is created and deleting a UII from the que when a predetermined time has elapsed after the check-in time.

42. The method according to claim 32, comprising receiving meta data related to the food item and adding the meta data to the data-record.

43. The method according to claim 42, wherein the meta data relates to at least one of:
the handling station or a human operator of the handling station;
a place where the food item is originally produced, and
a weight, a size, a shape, or a quality of the food item.

44. The method according to claim 32, comprising identifying in the check-in image an undesired food item part and creating at least one UII from a part of the image which does not contain the undesired food item part.

45. The method according to claim 32, comprising identifying in the check-in image an undesired food item part and creating at least one UII from a part of the image which does contain the undesired food item part.

46. The method according to claim 44, comprising grading the food item or the piece thereof depending on identification of the undesired food item part.

47. The method according to claim 32, comprising grading the food item or the piece thereof depending on if the recognition process establishes that a check-out image can be assigned to that UII or if the recognition process does not establish that a check-out image can be assigned to that UII.

48. The method according to claim 32, comprising defining based upon the check-in image, a portioning plan defining intended cutting of the food item into pieces thereof, and creating at least one UII for each of the intended pieces thereof.

49. The method according to claim 48, comprising cutting the food item into the intended pieces in a handling station.

50. The method according to claim 32, wherein the UII is generated based on a structural uniqueness of the food item or generated based on a size or shape of the food item or pieces thereof, or generated based on a color or color distribution of the food item, or combinations thereof.

51. The method according to claim 32, wherein the food item is selected from the group consisting of: vegetables, fruits, meat, poultry, fish, and seafood, or slices thereof.

52. The method according to claim 32, wherein the food item is salmon such as a fillet of salmon.

53. The method according to claim 32, wherein each food item or the pieces thereof in the flow of food items are categorized in at least a first category and a second category, the categorization being carried out between the check-in position and the check-out position, and wherein a food item or pieces thereof being in the first category is directed through the check-out position and wherein a food item or pieces thereof being in the second category is not directed through the check-out position.

54. The method according to claim 53, wherein a food item or pieces thereof being in the second category is directed through an alternative check-out position.

55. The method according to claim 53, comprising establishing a que of UII's of food items for which a check-in image is acquired at the check-in position and deleting from the que, a UII for a food item or a piece thereof which is categorized in the second category.

56. The method according to claim 32, comprising defining a data-record for each food item or pieces thereof at the check-out position, and if it could be established that the check-out image can be assigned to the created UII assigning the UII to that food item or pieces thereof.

57. A system for tracking a food item in a flow of food items through a handling facility, the system comprising:
a check-in camera arranged at a check-in position of the handling facility and configured to capture a check-in image of the food item;
a processing structure configured to create unique identification insignias (UII's) from the check-in image; and
a check-out camera arranged at a check-out position of the handling facility and configured to capture a check-out image of the food item or a piece thereof;
wherein the processing structure is configured to conduct a recognition process establishing if the check-out image can be assigned to the created UII; and configured, if it could be established that the check-out image can be assigned to the created UII, to define a data-record including the assigned UII.

58. The system according to claim 57, further comprising a process selector configured to select one of at least two further handling stations if the recognition process establishes that the check-out image can be assigned to the created UII; and configured to select another one of the at least two further handling stations if the recognition process establishes that the check-out image cannot be assigned to the created UII.

59. The system according to claim 57, wherein the processing structure is configured to establish a que of UII of food items for which a check-in image is acquired at the check-in position and to delete from the que, a UII if the recognition processor establishes that a check-out image can be assigned to that UII.

60. The system according to claim 59, wherein the processing structure is further configured to assign a check-in time to each UII when created, and to delete a UII from the que when a predetermined time has elapsed.

61. The system according to claim 60, comprising a sensor configured to determine a lead time for the food items from the check-in position to the check-out position, and
wherein the processing structure is configured to dynamically update the predetermined time based on the lead time.

62. The system according to claim 58, comprising a conveyor system configured to convey the food item from the check-in position to the check-out position.
